(19) United States
(12) Patent Application Publication
(10) Pub. No.: US 2026/0340516 A1
(43) Pub. Date: Oct. 29, 2026

(54) ANOMALY DETECTION USING AN ENSEMBLE OF PROCESSOR-BASED MACHINE LEARNING MODELS

(71) Applicant: Dell Products L.P., Round Rock, TX (US)

(72) Inventors: Rodrigo de Souza Scorsatto, Porto Alegre (BR); Thaynã da Silva França, Sao Leopoldo (BR); Rodrigo da Rosa Righi, Sao Leopoldo (BR); Cristiano Andre da Costa, Sao Leopoldo (BR); Jorge Luis Victoria Barbosa, Sao Leopoldo (BR)

(21) Appl. No.: 19/189,440

(22) Filed: Apr. 25, 2025

(51) Int. Cl. G06N 20/20

(52) U.S. Cl. CPC G06N 20/20

(57) ABSTRACT

Techniques are provided for anomaly detection using an ensemble of processor-based machine learning (ML) models. One method comprises obtaining feature values related to a given event; obtaining multiple ML models, wherein the ML models (i) are associated with corresponding predictive scores determined prior to an occurrence of the given event and (ii) have respective distinct ML model structures; applying the feature values to the ML models to obtain corresponding probability values; determining one or more weighted values for a set of behavior classes using the probability values and the predictive scores; and initiating processing steps based on at least one of the one or more weighted values. A predicted behavior class may be determined for the given event by comparing the one or more weighted values to at least one reliability threshold.

### BACKGROUND

Anomaly detection generally refers to techniques for identifying patterns or events that deviate from an expected behavior. These techniques can have a variety of applications, including detection of cyberattacks, identification of fraudulent or unauthorized transactions and prediction of equipment failures, as non-limiting examples. Anomaly detection can be an important factor in mitigating potential threats or enabling informed decision-making, for example.

### SUMMARY

Illustrative embodiments of the disclosure provide techniques for anomaly detection using an ensemble of processor-based machine learning (ML) models. One method includes accessing one or more data structures, wherein the one or more data structures comprise a plurality of feature values related to a given event; obtaining a plurality of ML models, wherein the plurality of ML models is associated with respective ones of a plurality of predictive scores determined prior to an occurrence of the given event, wherein the ML models have respective distinct ML model structures; applying the plurality of feature values to the plurality of ML models to obtain respective ones of a plurality of probability values; determining one or more weighted values for respective ones of a plurality of behavior classes using the plurality of probability values and the plurality of predictive scores; and initiating one or more processing steps based at least in part on at least one of the one or more weighted values.

Illustrative embodiments can provide significant advantages relative to conventional techniques. For example, technical problems related to such conventional techniques are mitigated in one or more embodiments by training and evaluating an ensemble of ML models to determine respective predictive powers of the ML models and to use the respective predictive powers to combine predictions into final predicted values.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for anomaly detection using an ensemble of processor-based ML models in accordance with an illustrative embodiment;

FIG. 2 illustrates a training and evaluation of an ensemble of ML models during an offline phase in accordance with an illustrative embodiment;

FIG. 3 illustrates a generation of predictions by the trained ensemble of ML models during an online phase in accordance with an illustrative embodiment;

FIGS. 4 and 5 are flow diagrams illustrating exemplary implementations of processes for anomaly detection using an ensemble of processor-based ML models in accordance with illustrative embodiments;

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for anomaly detection using an ensemble of processor-based ML models.

Anomaly detection can be an important factor in mitigating potential threats or enabling informed decision-making, for example. For example, anomalous activities may occur during a buying phase and/or a checkout phase of an e-commerce transaction. A nomalous behaviors may be revealed by the actions of resellers and/or fraudsters. Resellers, for example, may be responsible for a shortage of a given product, which is commonly observed when a popular product is released. A reseller customer may buy as much as possible of a given product with the goal of selling the product at a higher price in the future. It is often difficult in an e-commerce environment, however, to track and limit the number of purchased products per customer.

Rare event detection, for example, is a particular type of anomaly detection, where the objective is to detect events with high impact but low probability. The term “rare event” is intended to be broadly construed so as to encompass an occurrence of an event with a low probability of happening within a given context, process, or system. A rare event, in some embodiments, is based on whether a frequency of occurrence of an event falls below a configurable threshold within a defined dataset and/or timeframe.

In some embodiments, a gray market transaction can be considered as an example of a rare event. The gray market generally refers to the trade of products via a distribution channel that is unauthorized, unofficial and/or unintended by the original manufacturer and/or distributor. Gray markets often include genuine products that are sold outside of the normal distribution cycle and/or are imported into a market for sale without the consent or knowledge of the original manufacturer or owner. These products are generally sold at lower prices in a particular market than those offered by authorized distribution partners. Authorized price differentials to different markets and customers have created an opportunity for certain enterprises, such as brokers, to purchase branded products in one location at discounted rates and then move them to locations where they can bring greater profits. Gray markets have several negative consequences for the manufacturer and/or distributor of a given product, including decreased revenues, margin erosion, a negative reputation, service issues, warranty issues and/or reduced customer satisfaction.

In one or more embodiments, a multiclass approach is employed that enables identifying two or more types of user behavior. In some embodiments, the disclosed techniques for anomaly detection using an ensemble of processor-based ML models provide conservative predictions in real-time, which safeguards the relationship between a given company and its reliable customers (e.g., it is typically undesirable to misclassify a valid customer as a fraudster). In order to ensure trustworthy predictions, a reliability threshold may be employed in some embodiments to filter one or more of the ML models from the ensemble. In this manner, ML models having an overall performance lower than a previously defined reliability threshold value are removed from the ensemble.

In at least some embodiments, the disclosed ensemble-based anomaly detection techniques employ several different ML model structures trained on substantially the same training data and evaluated using substantially the same validation data, in an offline phase, in order to provide reliable predictions in real-time in an online phase. The training of the ensemble of ML models may employ supervised learning techniques that employ training data labeled with behavior class labels (e.g., identifying a particular user behavior associated with each transaction or other event in the training data). The training of the ensemble of ML models at substantially the same time allows the ML models to be evaluated to determine respective predictive powers and to use the respective predictive powers as weights to combine predictions into final predicted values.

While one or more embodiments are discussed herein in the context of e-commerce transactions, the disclosed ensemble-based anomaly detection techniques may be employed to predict behavior classes associated with transactions or other events in other contexts, such as engineering, healthcare or information technology, as would be apparent to a person of ordinary skill in the art.

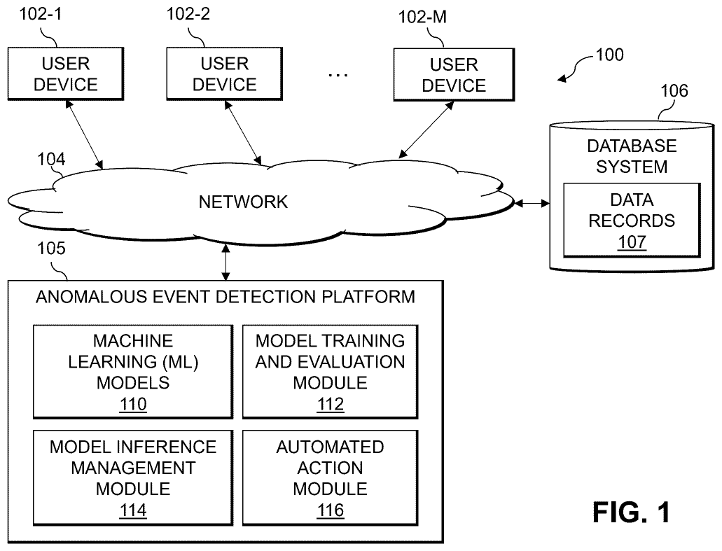

FIG. 1 shows an information processing system (sometimes referred to herein as a computer network) 100 configured in accordance with an illustrative embodiment. The information processing system 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger information processing system 100. Accordingly, elements 100 and 104 are both referred to herein as examples of “networks,” but the latter is assumed to be a component of the former in the context of the FIG. 1 embodiment. Also coupled to network 104 is an anomalous event detection platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks. The information processing system 100 in some embodiments therefore comprises combinations of multiple different types of networks, each comprising processing devices configured to communicate using internet protocol (IP) or other related communication protocols.

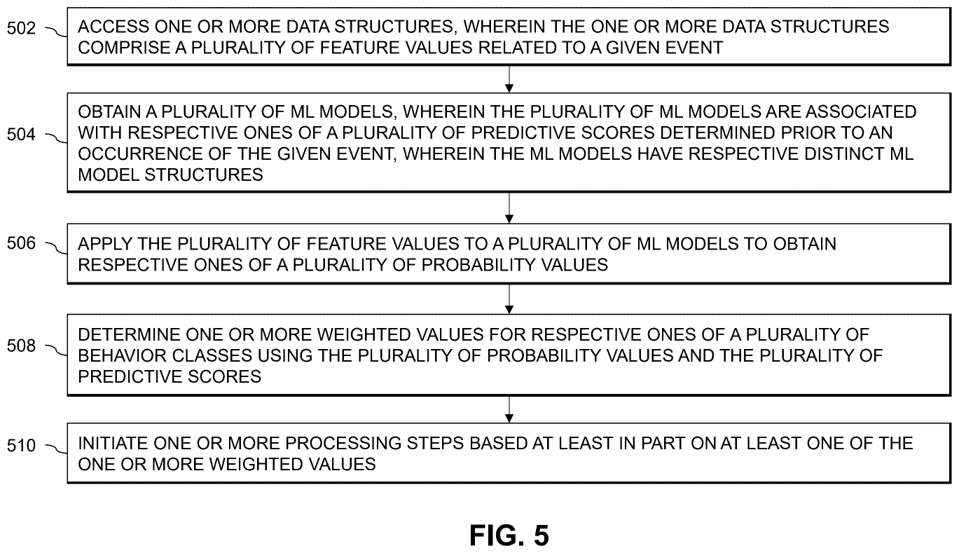

The anomalous event detection platform 105 may comprise a plurality of ML models 110, a model training and evaluation module 112, a model inference management module 114 and an automated action module 116. The ML models 110, in some embodiments, may perform anomaly detection in accordance with the disclosed techniques, as discussed further below in conjunction with FIG. 5, for example. The ML models 110 may be implemented, for example, using distinct ML model architectures, as discussed further below.

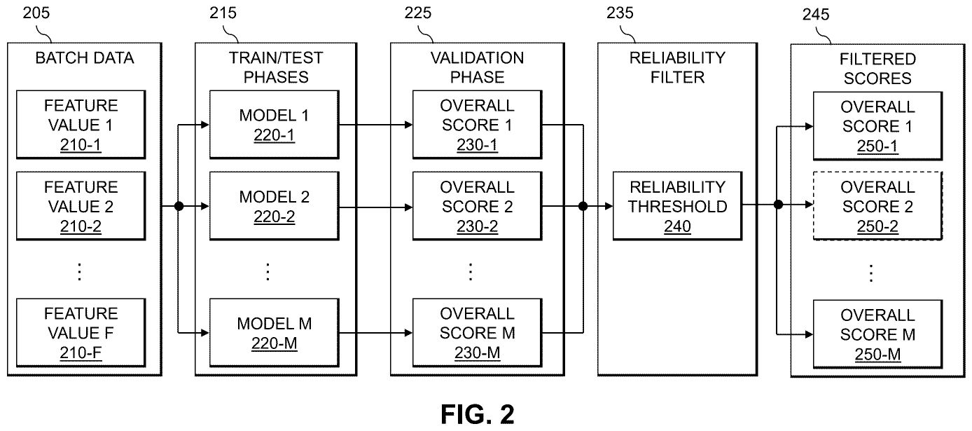

In at least some embodiments, the model training and evaluation module 112 may train an ensemble of different ML model structures using substantially the same training data and evaluate the ensemble of trained ML models using substantially the same validation data, in an offline phase, as discussed further below in conjunction with FIG. 2. In one or more embodiments, the model inference management module 114 may employ the ensemble of trained ML models in an online phase to generate predicted behavior classes in real-time (e.g., contemporaneously with the occurrence of a transaction or another event).

The automated action module 116 may perform one or more automated actions (e.g., processing steps) based at least in part on an anomaly result, such as generating a notification related to the anomaly result (e.g., a predicted behavior class), automatically denying a given transaction based at least in part on the anomaly result, automatically modifying the given transaction based at least in part on the anomaly result, providing one or more recommendations to adjust at least one parameter of the given transaction and causing an action to be performed in another system based at least in part on the anomaly result.

It is to be appreciated that this particular arrangement of elements 110, 112, 114 and/or 116 illustrated in the anomalous event detection platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

Additionally, the database system 106 may comprise one or more databases, such as data records 107 (e.g., comprising a dataset labeled with behavior class labels (e.g., identifying a particular user behavior associated with each transaction or event in the training data)). The data records 107 may be configured to store data, for example, in tables, in a known manner. While the database system 106 is illustrated in FIG. 1 as a single database, at least portions of the database system 106 may be implemented as multiple distinct databases. Example database system 106, such as depicted in the present embodiment, can be implemented using one or more storage systems associated with the anomalous event detection platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the anomalous event detection platform 105 are one or more input-output devices, which illustratively comprise keyboards, displays or other types of input-output devices in any combination. Such input-output devices can be used, for example, to support one or more user interfaces to the anomalous event detection platform 105, as well as to support communication between anomalous event detection platform 105 and other related systems and devices not explicitly shown.

Additionally, the anomalous event detection platform 105 in the FIG. 1 embodiment is assumed to be implemented using at least one processing device. Each such processing device generally comprises at least one processor and an associated memory, and implements one or more functional modules for controlling certain features of the anomalous event detection platform 105.

More particularly, the anomalous event detection platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the anomalous event detection platform 105 to communicate over the network 104 with the user devices 102, and illustratively comprises one or more conventional transceivers.

It is to be understood that the particular set of elements shown in FIG. 1 for the anomalous event detection platform 105 involving user devices 102 of information processing system 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the anomalous event detection platform 105 and at least portions of the database system 106 can be on and/or part of the same processing platform.

FIG. 2 illustrates a training and evaluation of an ensemble of ML models during an offline phase in accordance with an illustrative embodiment. As noted above, the disclosed ensemble-based anomaly detection techniques employ an ensemble of ML models having several different ML model structures trained on substantially the same training data and evaluated using substantially the same validation data, in an offline phase. The training of the ensemble of ML models may employ supervised learning techniques that employ training data labeled with behavior class labels.

In the example of FIG. 2, batch data 205 comprised of multiple feature values 210-1 through 210-F (e.g., associated with various transactions or other events) is initially obtained. In at least some embodiments, the data associated with each transaction or event within the batch data 205 is labeled with a given behavior class for supervised learning. The batch data 205 is separated into training/test data and validation data for use in a training and test phase 215 and a validation phase 225, respectively. In some embodiments, it is possible to train and test the ensemble of ML models, without performing a validation, and where the test dataset performs same function as the validation dataset.

In the training and test phase 215, the training data is used in the training phase to train multiple ML models 220-1 through 220-M. In at least some embodiments, each of the ML models 220 in the ensemble have different ML model structures, as discussed further below. The test data is used in the test phase to test the multiple trained ML models 220-1 through 220-M, in a known manner.

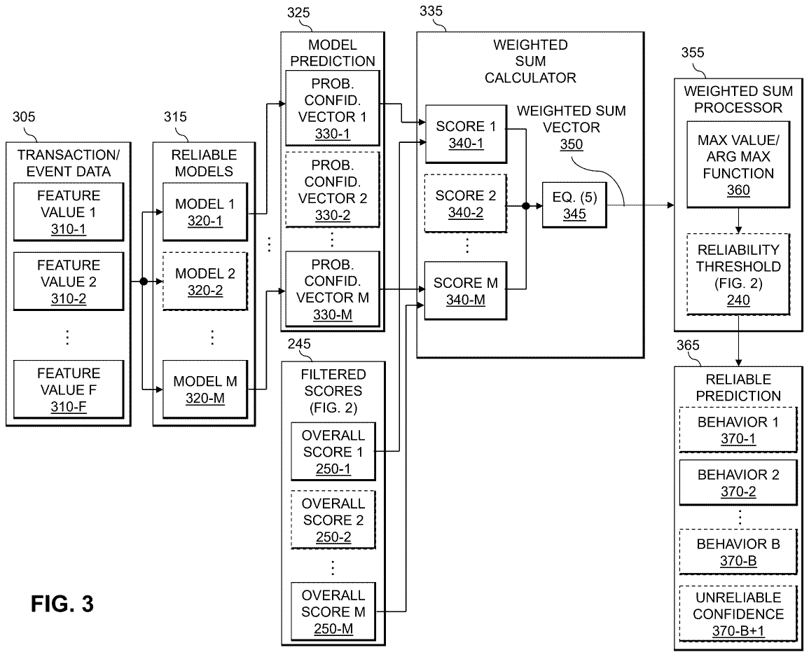

In the validation phase 225, the validation data is used to evaluate the multiple trained ML models 220-1 through 220-M and to generate respective overall scores (e.g., predictive scores) 230-1 through 230-M indicating respective predictive powers of the ML models 220. The overall scores (e.g., predictive scores) 230 can be used as weights to combine respective predictions of the ML models 220 into final predicted values, as discussed further below in conjunction with FIG. 3.

As noted above, in order to ensure trustworthy predictions, in at least some embodiments, a designated reliability threshold 240 is used by a reliability filter 235 to potentially filter ML models 220 from the ensemble. In this manner, any ML models 220 having an overall performance (e.g., characterized by the overall scores (e.g., predictive scores) 230) that does not satisfy the previously designated reliability threshold 240 may be removed from the ensemble. In the example of FIG. 2, the overall score 230-2 of model 220-2 does not satisfy the reliability threshold 240 and may be filtered from the overall scores 250 in the set of filtered scores 245, as indicated by the overall score 250-2 being shown with a dashed outline. In this manner, the model 220-2 will not be used in the online phase, as discussed further below in conjunction with FIG. 3.

In one or more embodiments, the reliability threshold 240 is a real value ranging from zero to one and defined according to a corporate policy. It is noted that higher reliability threshold values might establish a scenario where no ML model is selected, which may be considered as a system incapable of making predictions. Furthermore, from the validation phase, the overall scores 230 related to each ML model may be assessed.

As noted above, in at least some embodiments, each of the ML models 220 in the ensemble have different ML model structures. For example, the different ML model structures may comprise artificial neural networks (ANNs), decision trees (DTs), logistic regression (LR) models, random forest (RF) models, support vector machines (SVMs) or other ML model structures or architectures.

In at least one embodiment, automated ML techniques may be employed, whereby the ML models 220 in the ensemble may be retrained and/or re-validated using the techniques of FIG. 2. The automation of the training and/or validation phases may be performed in accordance with a given training policy, to maintain a reliable model in the production environment. The retraining and/or re-validation may be triggered based on time-based criteria (e.g., weekly or in accordance with another schedule, including aperiodic schedules) and/or event-based criteria (e.g., performance-based criteria, such as when one or more model scores do not satisfy a designated retraining threshold, or by accessing one or more additional evaluation metrics associated with the ensemble of ML models). The automated retraining and/or validation of the ensemble of ML models enables the adaptation of the ML models to address the natural change of user behavior in e-commerce platforms. Among other benefits, the automated retraining and/or validation of the ensemble of ML models can mitigate data drift problems and, as a consequence, avoid model degradation.

FIG. 3 illustrates a generation of predictions by the trained ensemble of ML models during an online phase in accordance with an illustrative embodiment. In the example of FIG. 3, transaction or event data 305 is initially obtained, comprising data for a given transaction or event. The transaction or event data 305 is comprised of multiple feature values 310-1 through 310-F (e.g., associated with various transactions or other events).

The feature values 310-1 through 310-F are applied to a set of reliable models 315 comprising trained ML models 320-1 through 320-M (e.g., those ML models that were not excluded by the reliability filtering of FIG. 2). As noted above in conjunction with FIG. 2, the overall score 230-2 of model 220-2 did not satisfy the reliability threshold 240 and was filtered from the overall scores 250 in the set of filtered scores 245. Thus, the model 220-2 is not used in the online phase of FIG. 3, as indicated by the corresponding model 320-2 being shown with a dashed outline.

In a model prediction phase 325, the trained ML models 320 in the filtered ensemble generate respective probability confidence vectors 330-1 through 330-M, in accordance with equation (2), discussed below. Since the model 220-2 is not being used in the online phase of FIG. 3, the probability confidence vector 330-2 that would be generated by the model 320-2 is not generated (or not used), as indicated by the probability confidence vector 330-2 being shown with a dashed outline.

FIG. 3 includes the filtered scores 245 that were generated using the techniques of FIG. 2. As noted above in conjunction with FIG. 2, the filtered overall score 250-2 of model 220-2 did not satisfy the reliability threshold 240 and was filtered from the overall scores 250 in the set of filtered scores 245, as indicated by the overall score 250-2 being shown with a dashed outline in FIG. 3 as well. In this manner, the model 320-2 and corresponding filtered overall score 250-2 are not used in the online phase of FIG. 3.

A weighted sum calculator 335 (or another weighted function) generates a set of respective scores 340-1 through 340-M, for the ML models 320 in the filtered ensemble, as discussed further below in conjunction with equation 4. The scores 340-1 through 340-M are generated based on a product of the respective probability confidence vectors 330 and the respective filtered overall score 250 for the trained ML models 320 in the filtered ensemble. For example, score 340-1 is based on a product of the corresponding probability confidence vector 330-1 and the overall score 250-1 of model 320-1. The scores 340-1 through 340-M are aggregated at step 345, for example, using equation (5), discussed below, to generate a weighted sum vector 350 (or another weighted function vector) having B components (e.g., one component for each designated behavior class).

The weighted sum vector 350 may be processed by a weighted sum processor 355 using a max value/arg max function 360 to obtain a maximum probability confidence value and a corresponding maximum probability confidence index, as discussed further below in conjunction with equations (6) and (7).

As noted above in conjunction with FIG. 2, the designated reliability threshold 240 in the reliability filter 235 may also be employed in some embodiments to filter the maximum probability confidence value to provide a reliable prediction 365. In other embodiments, one or more different thresholds may be employed in the offline phase and the online phase. In at least one embodiment, a final predicted behavior class is determined in accordance with equations 6 through 8.

In this manner, the online phase generates a reliable prediction 365 in a production environment. Thus, the ML models that were not excluded by the reliability filter 235 of FIG. 2, as well as their respective filtered overall scores 250, are used to perform real-time predictions in the online phase of FIG. 3. The weighted sum vector 350 may be employed to obtain the combined confidence level associated with the predicted behavior class of a given user from among the possible behavior classes 370-1 through 370-B. Thus, if the confidence value intrinsic to such a prediction is greater than the reliability threshold 240, a corresponding one of the predicted behavior classes 370-1 through 370-B generated by the ensemble of ML models is assigned to the user under consideration. In the example of FIG. 3, the reliable prediction 365 comprises behavior class 370-2, as indicated by the additional behavior classes 370 being shown with a dashed outline.

Otherwise, to favor further analysis, for example, the predicted behavior inherent to such a user may be characterized by a label associated with an unreliable confidence class 370-B+1, for example, when the designated reliability threshold 240 is not satisfied, as discussed further below in conjunction with equations 6 through 8.

The set of ML models and the number of possible behaviors (e.g., different behavior classes) from users equals to B (B∈ [symbol] *), where [symbol] * indicates the set of natural values that are non-zero, enable the training evaluation of such ML models, in accordance with the techniques of FIG. 2, with the goal of accessing the overall predictive score intrinsic to each model s (s∈[0,1]⊂ [symbol] ), where [symbol] indicates the set of real numbers (e.g., within the specified interval between 0 and 1), from a previously defined threshold value λ (λ∈[0, 1]⊂ [symbol] ). A reliability threshold or criterion may be established to filter the most reliable ML models. More precisely, for each existing ML model, if the overall score 230 of the considered ML model 220 is greater than the reliability threshold 240, then the ML model 220 is utilized in the online phase of FIG. 3. It is noted that after the filtering process, it can be assumed that a subset of the original ensemble of ML models survived the filtering process. M ore generally, the total number of models available in the ensemble (e.g., prior to the filtering) is equal to M (M∈ [symbol] +). Thus, as expressed in equation (1), set forth below, the overall scores 230 associated with the filtered models may be represented by the vector of overall scores s (s∈ [symbol] ^{F}), where RF indicates the set of real numbers of dimension F:

s=(s₁,s₂, . . . ,s_{M}). (1)

The prediction vector associated with each filtered model pₘ (pₘ∈ [symbol] ^{B}), where [symbol] ^{B} indicates the set of real numbers of dimension B (e.g., having the same dimension as the total number of possible behaviors), may be expressed using equation (2):

pₘ=(b_{m,1},b_{m,2}, . . . ,b_{m,B}). (2)

The components of each prediction vector comprise real values that may range from zero to one and such values represent the confidence in terms of a probability for each filtered model with respect to each type of behavior. For example, component b_{5,3} of the prediction vector characterizes the probability confidence inherent to the fifth filtered model with regard to the assertion that the considered user performs the third type of behavior. In at least some embodiments, founded on the rule of complementary events and regardless of the considered model, the sum of the probability confidences inherent to each possible behavior may be equal to one, as expressed by equation (3):

$${\sum }_{i = 1}^{B} {b}_{m , i} = 1 ( m = 1 , 2 , … , M ) . \qquad ( 3 )$$

It is possible to calculate the weighted sum vector 350 of FIG. 3 between the probability confidence vector 330 related to each type of behavior and the overall score intrinsic to each model. In detail, by considering the overall scores that were obtained in the validation step, it is feasible to represent the combined prediction associated with all filtered models that belong to the ensemble. Thus, an entity that may be referred to as an adjusted prediction vector wₘ (wₘ∈ [symbol] ^{B}) is defined, as expressed by equation (4):

wₘ=sₘb_{m,j} (j=1,2, . . . ,B). (4)

The weighted probability value for each different type of behavior (e.g., for each different behavior class 370) is given by a weighted sum vector 350. Specifically, by considering the set of filtered ML models, the prediction vector inherent to each model may be combined with its respective overall score so that an ensemble prediction vector e (e∈ [symbol] ^{B}) can be generated to perform a hybrid prediction for real-time inference, as expressed by equation (5):

$${e}_{j} = \frac{{\sum }_{i = 1}^{M} {w}_{i , j}}{{\sum }_{i = 1}^{M} {s}_{i}} ( j = 1 , 2 , … , B ) . \qquad ( 5 )$$

Without loss of generality, it is possible to define a one-to-one function that maps positive natural numbers into each existing behavior class 370 in a sorted fashion, which may be translated by the fact that an index of the ensemble prediction vector is associated with a specific behavior. The final prediction value is given by the maximum value of the ensemble prediction vector. Mathematically, the aforementioned final prediction value may be defined as the maximum probability confidence value α (α∈[0, 1]⊂ [symbol] ), as expressed by equation (6):

$$α = {max}_{1 \leq j \leq B} \{ {e}_{j} \} . \qquad ( 6 )$$

The index associated with the maximum probability confidence value may be defined as the maximum probability confidence index β (β∈[1, B]⊂N*), as expressed by equation (7):

$$β = {arg max}_{1 \leq j \leq B} \{ {e}_{j} \} . \qquad ( 7 )$$

The maximum probability confidence value can optionally be filtered (e.g., by comparing a from equation (6) to the reliability threshold, λ) to obtain a conservative outcome with regard to the predicted behavioral class, as expressed by equation (8):

$$prediction = \{ \begin{matrix}behavior β , α > λ \\ weak prediction , α \leq λ\end{matrix} . \qquad ( 8 )$$

In some embodiments of the disclosure, bagging and/or boosting techniques may be employed, for example, in a hybrid approach. For example, the parallel training techniques of FIG. 2 may be based at least in part on existing bagging techniques. Likewise, the prediction techniques of FIG. 3, where weighted sums are used to make a prediction decision with improved reliability, may be based at least in part on existing boosting techniques.

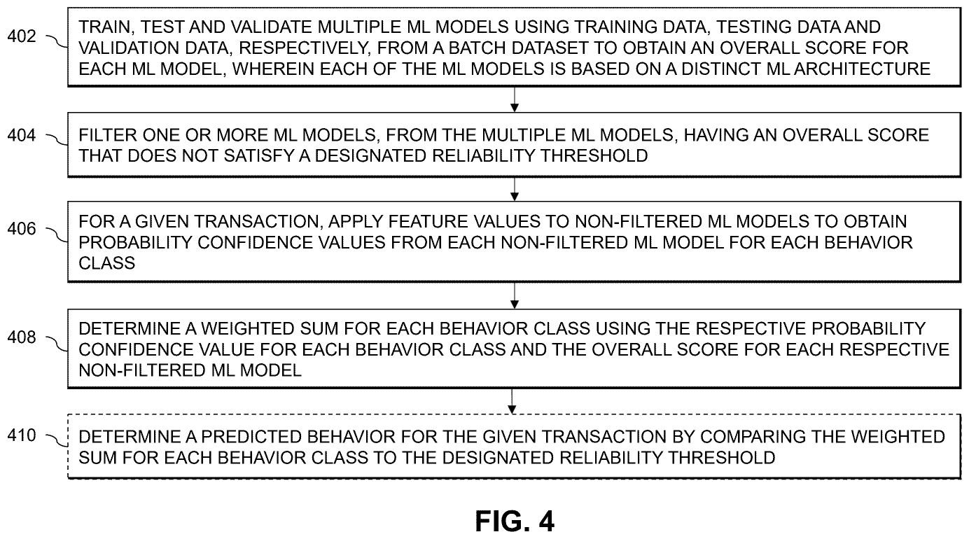

FIG. 4 is a flow diagram illustrating an exemplary implementation of a process for anomaly detection using an ensemble of processor-based ML models in accordance with an illustrative embodiment. In the example of FIG. 4, multiple ML models are trained, tested and validated in step 402 using training data, testing data and validation data, respectively, from a batch dataset (e.g., batch dataset 205) to obtain an overall score (e.g., a predictive score) for each ML model, wherein each of the ML models is based on a distinct ML architecture, as discussed above in conjunction with FIG. 2.

In step 404, one or more of the ML models, having an overall score that does not satisfy a designated reliability threshold, are filtered from the multiple ML models. For a given transaction, feature values for the given transaction are applied to the non-filtered ML models in step 406 to obtain probability confidence values from each filtered ML model for each behavior class.

A weighted sum is determined in step 408 for each behavior class using the respective probability confidence value for each behavior class and the overall score for each respective non-filtered ML model, for example, as discussed above in conjunction with equations 4 and 5. In step 410, a predicted behavior for the given transaction is optionally determined by comparing the weighted sum for each behavior class to the designated reliability threshold.

FIG. 5 is a flow diagram illustrating an exemplary implementation of a process for anomaly detection using an ensemble of processor-based ML models in accordance with an illustrative embodiment. In the example of FIG. 5, one or more data structures are accessed in step 502, wherein the one or more data structures comprise a plurality of feature values related to a given event.

A plurality of ML models is obtained in step 504, wherein the plurality of ML models is associated with respective ones of a plurality of predictive scores determined prior to an occurrence of the given event, wherein the ML models have respective distinct ML model structures. In step 506, the plurality of feature values is applied to the plurality of ML models to obtain respective ones of a plurality of probability values.

One or more weighted values (e.g., weighted sums) for respective ones of a plurality of behavior classes are determined in step 508 using the plurality of probability values and the plurality of predictive scores. One or more processing steps are initiated in step 510 based at least in part on at least one of the one or more weighted values.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example.

In one or more embodiments, one or more of the plurality of ML models may be trained using a plurality of behavior class labels and at least one supervised learning technique. The plurality of ML models may be trained at a substantially same time to obtain the respective predictive score of each of the ML models, and wherein the respective predictive score of the plurality of ML models may be used to combine respective predictions of the plurality of ML models into a final predicted value. The plurality of ML models, based on the plurality of distinct ML model structures, may be two or more of: trained using a substantially same training dataset, tested using a substantially same testing dataset and validated using a substantially same validation dataset. The plurality of ML models may comprise a subset of a larger set of ML models, wherein one or more ML models, having a predictive score that did not satisfy the at least one reliability threshold, were removed from the larger set of ML models.

In some embodiments, the process of FIG. 5 further comprises determining a predicted behavior class for the given event by comparing the respective weighted values for the plurality of behavior classes to at least one reliability threshold. The predicted behavior class may be obtained prior to a conclusion of the given event. The predicted behavior class may comprise one or more of a reseller behavior, a fraudulent behavior, a typical behavior, an anomalous behavior and an unreliable confidence behavior. Each of the plurality of probability values may comprise a vector indicating a probability of each of the plurality of behavior classes.

In at least one embodiment, the one or more weighted values for the respective behavior classes comprise a weighted sum for each predicted behavior class of the plurality of predicted behavior classes. The one or more processing steps may comprise at least one of: generating a notification related to the one or more weighted values, automatically denying the given event, automatically modifying at least one characteristic of the given event and causing an action to be performed in another system based at least in part on the one or more weighted values. In this manner, one or more of the processing steps may be employed to mitigate a detected anomaly (e.g., by notifying a user of the anomalous transaction or event, automatically denying an anomalous transaction or event and/or automatically modifying one or more characteristics of a given transaction or event to address the anomaly). The plurality of distinct ML model structures may comprise two or more of: an artificial neural network, a decision tree, a logistic regression model, a random forest model and a support vector machine.

The particular processing operations and other network functionality described in conjunction with FIGS. 2 through 5, for example, are presented by way of illustrative example only, and should not be construed as limiting the scope of the disclosure in any way. Alternative embodiments can use other types of processing operations for anomaly detection using an ensemble of processor-based ML models. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

Among other benefits, the disclosed ensemble-based anomaly detection techniques allow the models in the ensemble to work together with a common goal of producing a more reliable prediction, rather than having the models compete with one another. In addition, an automated retraining and validation of the ensemble of ML models, in the manner described herein, mitigates a data drift problem and avoids model degradation.

One or more embodiments of the disclosure provide improved methods, apparatus and computer program products for anomaly detection using an ensemble of processor-based ML models. The foregoing applications and associated embodiments should be considered as illustrative only, and numerous other embodiments can be configured using the techniques disclosed herein, in a wide variety of different applications.

It should also be understood that the disclosed techniques for anomaly detection using an ensemble of processor-based ML models, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for anomaly detection using an ensemble of processor-based ML models may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based anomaly detection engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based anomaly detection platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

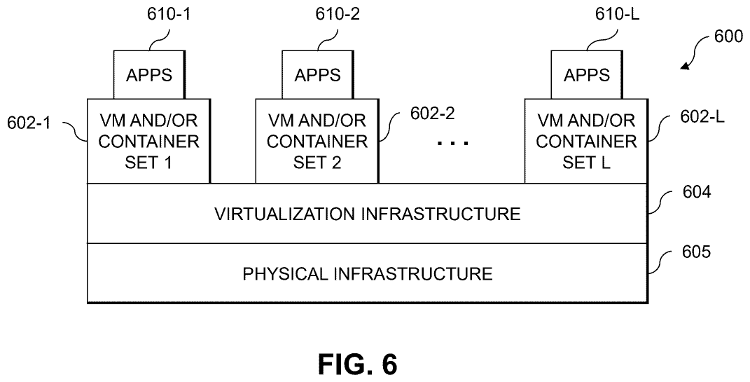

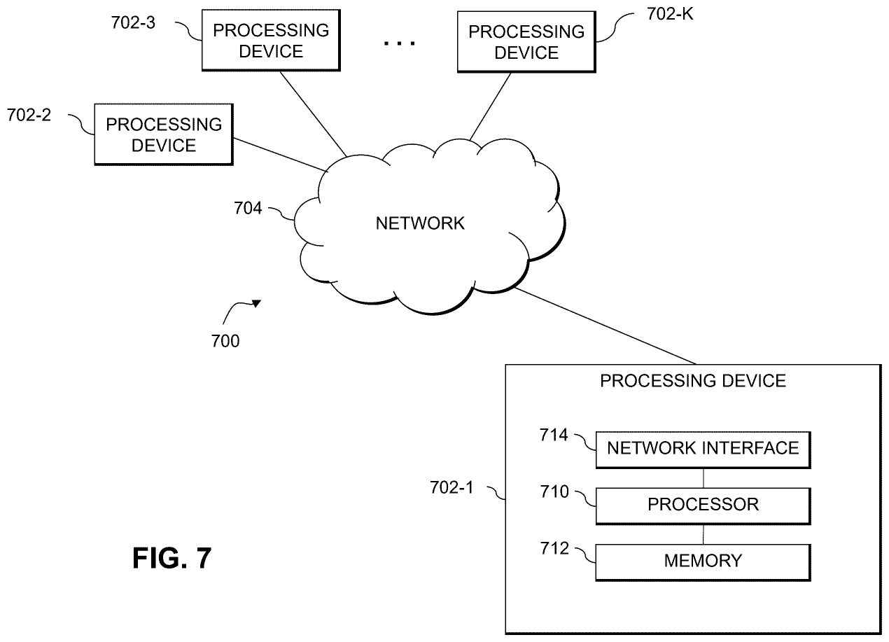

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide ensemble-based anomaly detection functionality of the type described above for one or more processes running on a given one of the VMs. For example, each of the VMs can implement control logic for ensemble-based anomaly detection and associated functionality for training and validating ML models to obtain respective predictive scores of the ML models that may be used to combine respective predictions of the ML models into final predicted values.

An example of a hypervisor platform that may be used to implement a hypervisor within the virtualization infrastructure 604 is a compute virtualization platform which may have an associated virtual infrastructure management system such as server management software. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide ensemble-based anomaly detection functionality of the type described above for one or more processes running on different ones of the containers. For example, a container host device supporting multiple containers of one or more container sets can implement one or more instances of control logic for ensemble-based anomaly detection and associated functionality for training and validating ML models to obtain respective predictive scores of the ML models that may be used to combine respective predictions of the ML models into final predicted values.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a WAN, a LAN, a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

A gain, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 6 or 7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LX Cs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. M any variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
accessing one or more data structures, wherein the one or more data structures comprise a plurality of feature values related to a given event;
obtaining a plurality of machine learning (ML) models, wherein the plurality of ML models is associated with respective ones of a plurality of predictive scores determined prior to an occurrence of the given event, wherein the ML models have respective distinct ML model structures;
applying the plurality of feature values to the plurality of ML models to obtain respective ones of a plurality of probability values;
determining one or more weighted values for respective ones of a plurality of behavior classes using the plurality of probability values and the plurality of predictive scores; and
initiating one or more processing steps based at least in part on at least one of the one or more weighted values;
wherein the method is performed by at least one processing device comprising a processor coupled to a memory.

2. The method of claim 1, wherein one or more of the plurality of ML models is trained using a plurality of behavior class labels and at least one supervised learning technique.

3. The method of claim 1, further comprising determining a predicted behavior class for the given event by comparing the respective one or more weighted values for the respective ones of the plurality of behavior classes to at least one reliability threshold.

4. The method of claim 3, wherein the predicted behavior class is obtained prior to a conclusion of the given event.

5. The method of claim 3, wherein the predicted behavior class comprises one or more of a reseller behavior, a fraudulent behavior, a typical behavior, an anomalous behavior and an unreliable confidence behavior.

6. The method of claim 1, wherein the plurality of ML models is trained at a substantially same time to obtain the respective predictive score of each of the ML models, and wherein the respective predictive scores of the plurality of ML models are used to combine respective predictions of the plurality of ML models into a final predicted value.

7. The method of claim 1, wherein the plurality of ML models, based on the plurality of distinct ML model structures, is two or more of: trained using a substantially same training dataset, tested using a substantially same testing dataset and validated using a substantially same validation dataset.

8. The method of claim 1, wherein the plurality of ML models comprises a subset of a larger set of ML models, wherein one or more ML models, having a predictive score that did not satisfy the at least one reliability threshold, were removed from the larger set of ML models.

9. The method of claim 1, wherein the one or more weighted values for the respective ones of the plurality of behavior classes comprise a weighted sum for each behavior class of the plurality of predicted behavior classes.

10. The method of claim 1, wherein the one or more processing steps comprise at least one of: generating a notification related to the one or more weighted values, automatically denying the given event, automatically modifying at least one characteristic of the given event and causing an action to be performed in another system based at least in part on the one or more weighted values.

11. The method of claim 1, wherein the plurality of distinct ML model structures comprises two or more of: an artificial neural network, a decision tree, a logistic regression model, a random forest model and a support vector machine.

12. The method of claim 1, wherein each of the plurality of probability values comprises a vector indicating a probability of each of the plurality of behavior classes.

13. An apparatus comprising:
at least one processing device comprising a processor coupled to a memory;
the at least one processing device being configured to implement the following steps:
accessing one or more data structures, wherein the one or more data structures comprise a plurality of feature values related to a given event;
obtaining a plurality of machine learning (ML) models, wherein the plurality of ML models is associated with respective ones of a plurality of predictive scores determined prior to an occurrence of the given event, wherein the ML models have respective distinct ML model structures;
applying the plurality of feature values to the plurality of ML models to obtain respective ones of a plurality of probability values;
determining one or more weighted values for respective ones of a plurality of behavior classes using the plurality of probability values and the plurality of predictive scores; and
initiating one or more processing steps based at least in part on at least one of the one or more weighted values.

14. The apparatus of claim 13, further comprising determining a predicted behavior class for the given event by comparing the respective one or more weighted values for the respective ones of the plurality of behavior classes to at least one reliability threshold.

15. The apparatus of claim 13, wherein the plurality of ML models is trained at a substantially same time to obtain the respective predictive score of each of the ML models, and wherein the respective predictive scores of the plurality of ML models are used to combine respective predictions of the plurality of ML models into a final predicted value.

16. The apparatus of claim 13, wherein the plurality of ML models comprises a subset of a larger set of ML models, wherein one or more ML models, having a predictive score that did not satisfy the at least one reliability threshold, were removed from the larger set of ML models.

17. A non-transitory processor-readable storage medium having stored therein program code of one or more software programs, wherein the program code when executed by at least one processing device causes the at least one processing device to perform the following steps:
accessing one or more data structures, wherein the one or more data structures comprise a plurality of feature values related to a given event;
obtaining a plurality of machine learning (ML) models, wherein the plurality of ML models is associated with respective ones of a plurality of predictive scores determined prior to an occurrence of the given event, wherein the ML models have respective distinct ML model structures;
applying the plurality of feature values to the plurality of ML models to obtain respective ones of a plurality of probability values;
determining one or more weighted values for respective ones of a plurality of behavior classes using the plurality of probability values and the plurality of predictive scores; and
initiating one or more processing steps based at least in part on at least one of the one or more weighted values.

18. The non-transitory processor-readable storage medium of claim 17, further comprising determining a predicted behavior class for the given event by comparing the respective one or more weighted values for the respective ones of the plurality of behavior classes to at least one reliability threshold.

19. The non-transitory processor-readable storage medium of claim 17, wherein the plurality of ML models is trained at a substantially same time to obtain the respective predictive score of each of the ML models, and wherein the respective predictive scores of the plurality of ML models are used to combine respective predictions of the plurality of ML models into a final predicted value.

20. The non-transitory processor-readable storage medium of claim 17, wherein the plurality of ML models comprises a subset of a larger set of ML models, wherein one or more ML models, having a predictive score that did not satisfy the at least one reliability threshold, were removed from the larger set of ML models.
